(19) United States
(12) Patent Application Publication
(10) Pub. No.: US 2026/0012795 A1
(43) Pub. Date: Jan. 8, 2026

(54) INFORMATION SECURITY DETECTION METHOD AND INFORMATION SECURITY DETECTION DEVICE

(71) Applicant: INSTITUTE FOR INFORMATION INDUSTRY, TAIPEI CITY (TW)

(72) Inventors: YI-HSUEH TSAI, Taipei (TW); Jie-Wei Chen, Taipei (TW)

(21) Appl. No.: 18/811,037

(22) Filed: Aug. 21, 2024

(30) Foreign Application Priority Data
Jul. 3, 2024 (TW) 113124786

(51) Int. Cl. H04W 12/37; H04W 12/69; H04W 24/06

(52) U.S. Cl. CPC H04W 12/37; H04W 12/69; H04W 24/06

(57) ABSTRACT

An information security detection method and an information security detection device are provided. The method includes: configuring the UE to transmit an uplink NAS transport message and a PDU session establishment request to the core network through the base station; configuring the base station to receive a first signaling and a second signaling from the core network through an N2 interface; capturing the first signaling and checking whether or not the first signaling contains a security indication IE; in response to determining that the security indication IE is contained in the first signaling, configuring an information security detection device to determine whether or not the security indication IE is consistent with a UP security policy of a UDM entity of the core network, so as to determine whether or not an SMF entity of the core network passes a first security test case.

### CROSS-REFERENCE TO RELATED PATENT APPLICATION

This application claims the benefit of priority to Taiwan Patent Application No. 113124786, filed on Jul. 3, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method and a device, and more particularly to an information security detection method and an information security detection device.

### BACKGROUND OF THE DISCLOSURE

The 3rd generation partnership project (3GPP) defines security requirements and test cases for network elements in the 5G security assurance specification (SCAS). As mentioned in technical specifications versions 33.515 and 33.513, unique security requirements are defined for the user plane function (UPF) and session management function (SMF) of the core network, respectively. These specific security requirements include security function requirements for UPF and SMF in the relevant specifications and the test cases related to the security requirements.

However, in the security test cases involving SMF and UPF in the above specifications, it is necessary to obtain SBI interface information and N4 interface information of the SMF. However, the SBI interface information and N4 interface information of the existing 5GC equipment vendors are not easy to obtain, making it difficult to complete the SMF and UPF security test cases to ensure information security.

### SUMMARY OF THE DISCLOSURE

In response to the above-referenced technical inadequacies, the present disclosure provides an information security detection method and an information security detection device capable of implement partial SMF and UPF security test cases in a simple way.

In order to solve the above-mentioned problems, one of the technical aspects adopted by the present disclosure is to provide an information security detection method, applicable to executing following processes in response to a user equipment (UE), a base station and a core network establishing a connection: configuring the UE to transmit an uplink non-access stratum (NAS) transport message and a protocol data unit (PDU) session establishment request to the core network through the base station; configuring the base station to receive a first signaling and a second signaling from the core network through an N2 interface; capturing the first signaling by an information security detection device, and determining whether or not the first signaling contains a security indication information element (IE); and in response to the information security detection device determining that the security indication IE is contained in the first signaling, configuring the information security detection device to determine whether or not the security indication IE is consistent with a user plane (UP) security policy of a unified data management (UDM) entity of the core network, so as to determine whether or not a session management function (SMF) entity of the core network passes a first security test case.

In order to solve the above-mentioned problems, another one of the technical aspects adopted by the present disclosure is to provide an information security detection device, which includes a memory and a processing circuit. The memory stores a plurality of instructions, the processing circuit is electrically connected to the memory and configured to read the instructions and execute following processes: communicatively establishing a connection through a user equipment (UE), a base station and a core network; configuring the UE to transmit an uplink non-access stratum (NAS) transport message and a protocol data unit (PDU) session establishment request to the core network through the base station; configuring the UE to receive a first signaling and a second signaling from the core network through an N2 interface of the base station; capturing the first signaling and checking whether or not the first signaling contains a security indication information element (IE); and in response to determining that the security indication IE is contained in the first signaling, determining whether or not the security indication IE is consistent with a user plane (UP) security policy of a unified data management (UDM) entity of the core network, so as to determine whether or not a session management function (SMF) entity of the core network passes a first security test case.

Therefore, in the information security detection method and information security detection device provided by the present disclosure, packets of the N2 interface and the N3 interface can be captured and analyzed, while referring to the UP security policy of the UDM entity, so as to reduce the difficulty of obtaining the necessary information required for the information security test cases, and implement certain SMF and UPF security test cases in a simpler way, thereby greatly improving the feasibility of realizing such information security test cases.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an information security detection device according to one embodiment of the present disclosure;

FIG. 2 is a first flowchart of the information security detection method according to an embodiment of the present invention;

FIG. 3 is a first timing diagram of the information security detection method according to one embodiment of the present disclosure;

FIG. 4 is a second flowchart of the information security detection method according to one embodiment of the present disclosure;

FIG. 5 is a third flowchart of the third step of the information security detection method according to the embodiment of the present disclosure; and

FIG. 6 is a second timing diagram of the information security detection method according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

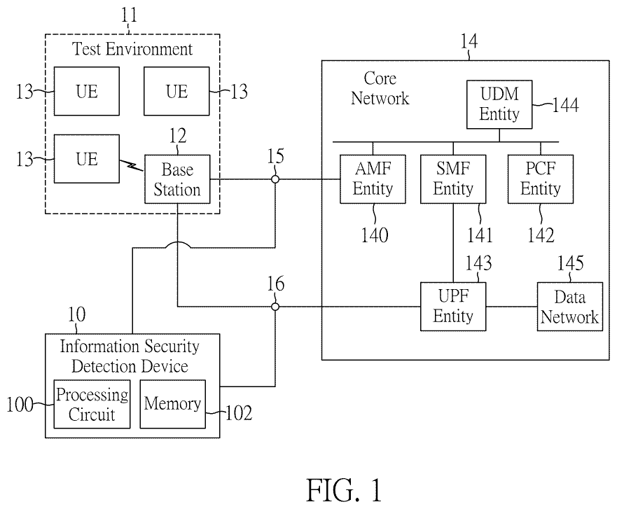

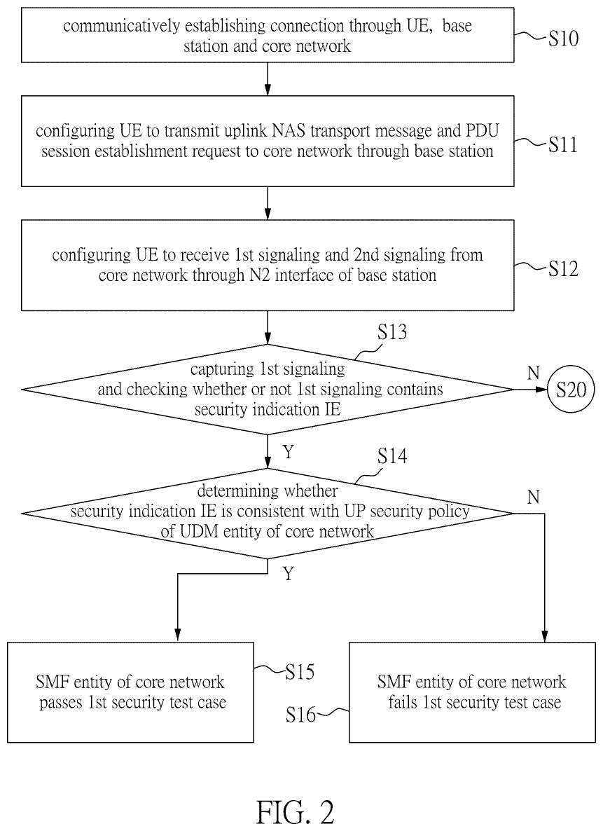

Referring to FIG. 1 and FIG. 2, FIG. 1 is a functional block diagram of an information security detection device according to one embodiment of the present disclosure, and FIG. 2 is a first flowchart of the information security detection method according to an embodiment of the present invention. As shown in FIG. 1, the information security detection device 10 of the present embodiment can be coupled to a base station (gNodeB) 12 and a core network 14, and includes a processing circuit 100 and a memory 102. Specifically, the information security detection device 10 can be, for example, a network test access point (TAP), which is used to continuously capture and analyze packets transmitted between the base station 12 and the core network 14 through a first interface 15 and a second interface 16 without interfering or interrupting network traffic and affecting the network integrity. In this embodiment, the first interface 15 and the second interface 16 can be an N2 interface and an N3 interface, respectively.

As shown in FIG. 2, the information security detection device 10 of the present embodiment can be used to implement the information security detection method provided by the present disclosure. For example, the memory 102 can store a plurality of instructions, and the processing circuit 100 is electrically connected to the memory 102 and configured to read the instructions and execute the following steps:

Step S10: communicatively establishing a connection through a user equipment (UE), a base station and a core network. In step S10, a test environment 11 can be executed by the information security detection device 10 or other hardware equipment to establish a virtual base station 12 and multiple user equipment 13 in a simulation manner, so as to further simulate messages (including content to be transmitted) and steps required before and after the base station 12, the user equipment 13 and the core network 14 are communicatively connected to one another. In addition, in step S10, the base station 12 can be configured to disable encryption mechanism of the first interface 15 and the second interface 16, or the information security detection device 10 can be configured to establish a connection with a security gateway of the core network 14, thereby ensuring that packets transmitted through the first interface 15 and the second interface 16 can be successfully captured and analyzed.

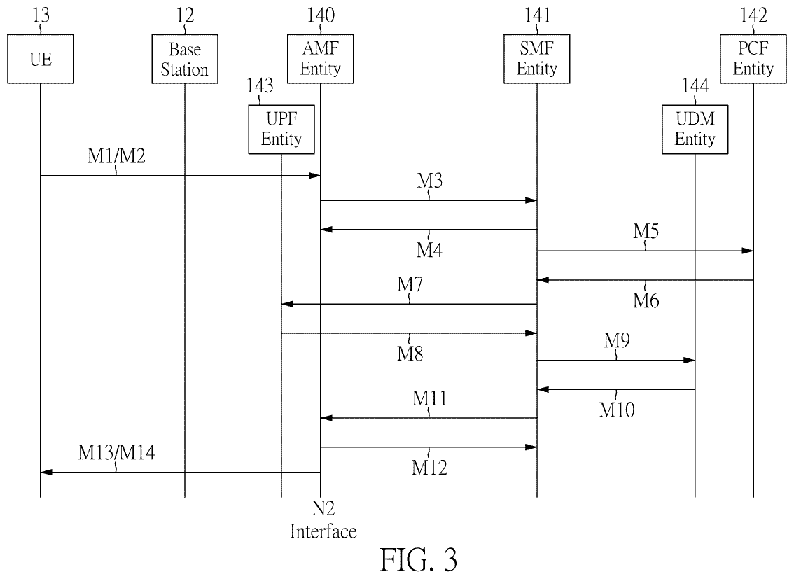

Step S11: configuring the UE to transmit an uplink non-access stratum (NAS) transport message and a protocol data unit (PDU) session establishment request to the core network through the base station. Referring to FIG. 3, FIG. 3 is a first timing diagram of the information security detection method according to one embodiment of the present disclosure. In step S11, the user equipment 13 can transmit the uplink NAS transport message M1 and the PDU session establishment request M2 to an access and mobility function (AMF) entity 140 of the core network 14 through the base station 12.

It should be noted that after the UE 13 transmits the uplink NAS transport message M1 and the PDU session establishment request M2 to the AMF entity 140 through the base station 12, the AMF entity 140 further transmits a PDU session establishment message M3 to a session management function (SMF) entity 141. After the request is successful, the SMF entity 141 returns a request success message M4 to the AMF entity 140 and communicates with a policy control function (PCF) entity 142 of the core network 14. During the communication process, the SMF entity 141 can send a session management (SM) policy association request M5 to the PCF entity 142. After the request is successful, the PCF entity 142 will return a request success message M6 to the SMF entity 141 and generate corresponding SM policy information.

Next, the SMF entity 141 transmits a packet data convergence protocol (PDCP) session establishment request M7 to a user plane function (UPF) entity 143. In response to receiving a PDCP session establishment response M8 from the UPF entity 143, the SMF entity 141 further obtains a user plane (UP) security policy from a unified data management (UDM) entity 144. In detail, the SMF entity 141 can first send a session management (SM) data request M9 to the UDM entity to require for returning the UP security policy, and the UDM entity 144 returns the UP security policy data required to the SMF entity 141 along with a request success message M10.

Step S12: configuring the UE to receive a first signaling and a second signaling from the core network through an N2 interface of the base station. In step S12, the UE receives the first signaling and the second signaling from the AMF entity 140 through the N2 interface of the base station, the first signaling is a PDU session resource setup request signaling, and the second signaling is a PDU session establishment accept signaling.

In step S12, as shown in FIG. 3, the SMF entity 141 can send an N1/N2 message transfer request M11 to the AMF entity 140, and after the AMF entity 140 returns a request success message M12, the SMF entity 141 further transmits a PDU session resource setup request signaling M13 and the PDU session establishment accept signaling M14 to the UE 13 through the first interface 15 (e.g., the N2 interface) of the base station 12.

Step S13: capturing the first signaling and checking whether or not the first signaling contains a security indication information element (IE). In step S13, the information security detection device 10 can capture packets received through the first interface 15 of the base station 12, so as to extract and analyze the PDU session resource setup request signaling M13 of the captured packets.

In response to determining that the security indication IE is contained in the first signaling, the security information detection method proceeds to step S14: determining whether or not the security indication IE is consistent with the UP security policy of the UDM entity of the core network, so as to determine whether or not the SMF entity of the core network passes a first security test case.

In detail, in 3GPP's 5G security assurance specification (SCAS), test cases for the SMF entity are defined in the technical specification (TS) version 33.515, such as priority of UP security policy test required in chapter 4.2.2.1.1. In step S14, a management interface of the UDM entity 144 of the core network 14 provided by 5G network provider can be used to determine whether or not parameters set in the UP security policy are the same as the security indication IE in the PDU session resource setup request signaling M13.

In response to the parameters set in the UP security policy are the same as the security indication IE in the PDU session resource setup request signaling M13, the information security detection method proceeds to step S15: determining that the SMF entity of the core network passes the first security test case. In response to the parameters set in the UP security policy being different from the security indication IE in the PDU session resource setup request signaling M13, the information security detection method proceeds to step S16: determining that the SMF entity of the core network fails the first security test case.

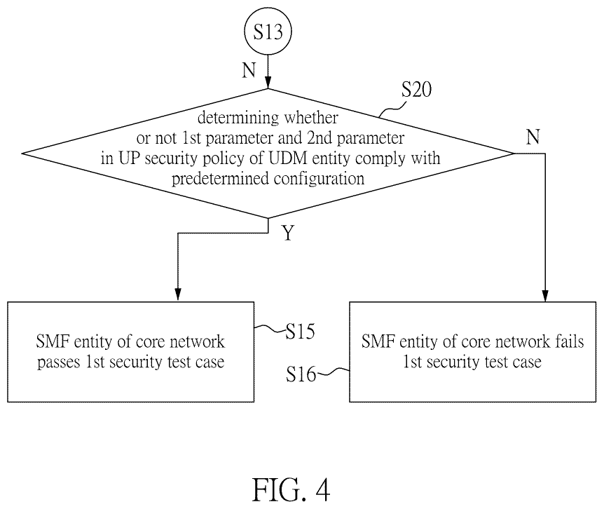

On the other hand, in response to determining in step S13 that the security indication IE is not contained in the first signaling, the information security detection method proceeds to step S20. Referring to FIG. 4, FIG. 4 is a second flowchart of the information security detection method according to one embodiment of the present disclosure. As shown in FIG. 4, the information security detection method proceeds to step S20: determining, by the information security detection device, whether or not a first parameter and a second parameter in the UP security policy of the UDM entity comply with a predetermined configuration. For example, two parameters, “upInter” and “upConfid”, are defined in the UP security policy of the UDM entity 144. The parameter “upInter” is used to indicate whether an integrity check is required, and the parameter “upConfid” is used to indicate whether UP confidentiality protection is required. If the predetermined configuration does not require integrity checking but requires UP confidentiality protection, corresponding values of the parameters “upInter” and “upConfid” are “NOT NEEDED” and “REQUIRED”, respectively. Therefore, if the security indication IE is not contained in the PDU session resource setup request signaling M13, the above parameters in the PDU session resource setup request signaling M13 can be directly checked in step S20 to determine whether or not the SMF entity passes the first security test case.

In response to determining in step S20 that the first parameter and the second parameter in the UP security policy of the UDM entity comply with the predetermined configuration, the information security detection method proceeds to step S15: determining that the SMF entity of the core network passes the first security test case. Otherwise, the information security detection method proceeds to step S16: determining that the SMF entity of the core network fails the first security test case.

Therefore, in this embodiment, by capturing and analyzing the packets of the N2 interface while referring to the UP security policy of the UDM entity 144, the difficulty of obtaining necessary information required for the information security detection test case can be reduced, and a part of test cases related to security functional requirements on the SMF can be implemented in a simpler way.

In addition to the first security test case for the SMF entity (e.g., priority of UP security policy), the information security detection device and the information security detection method provided by the present disclosure can also detect whether or not the SMF entity passes a second security test case and the UPF entity passes a third security test case. For example, in 3GPP's 5G SCAS, a tunnel endpoint identifier (TEID) uniqueness security test case for SMF is defined in section 4.2.2.1.2 of TS version 33.515, and a TEID uniqueness security test case for UPF is defined in section 4.2.2.6 of TS version 33.513.

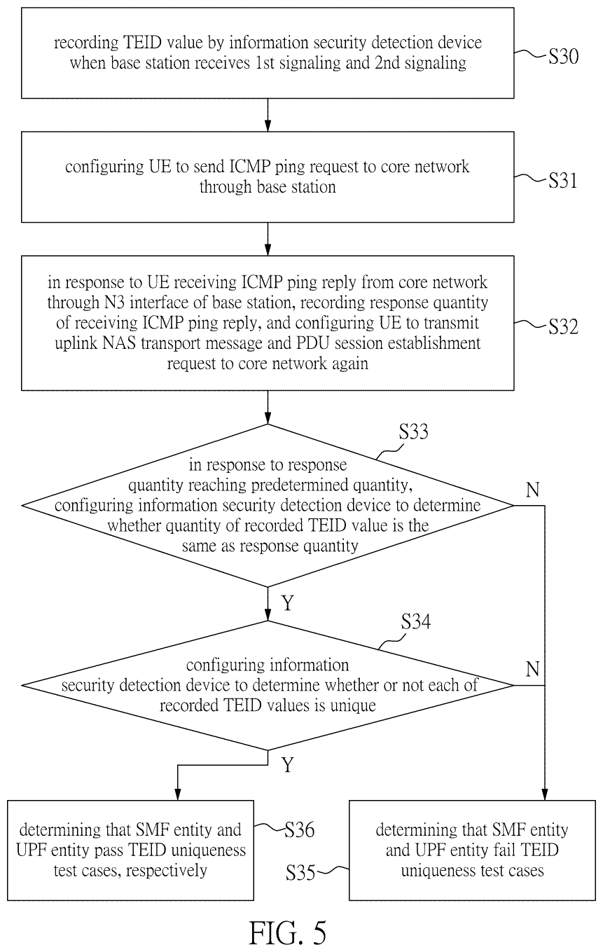

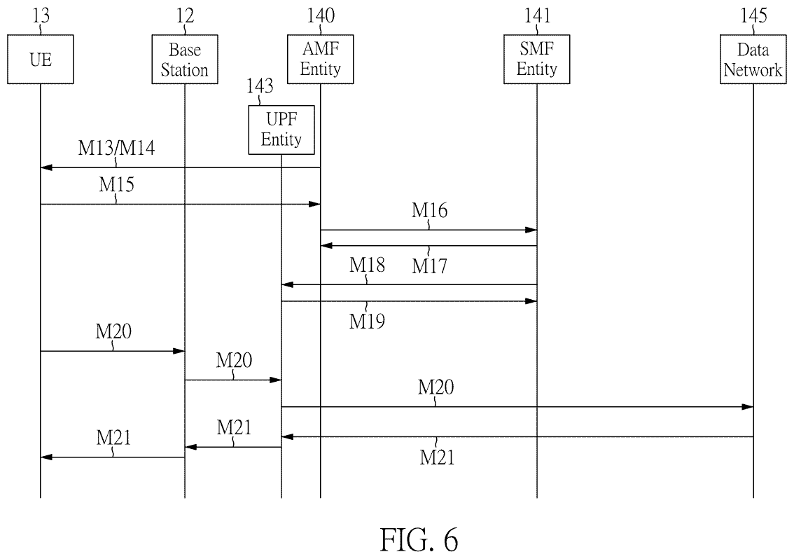

FIG. 5 is a third flowchart of the third step of the information security detection method according to the embodiment of the present disclosure, and FIG. 6 is a second timing diagram of the information security detection method according to one embodiment of the present disclosure.

Referring to FIG. 6, based on FIG. 2, the information security detection method provided by the embodiment of the present disclosure further includes the following steps:

Step S30: recording a tunnel endpoint identifier (TEID) value by the information security detection device when the base station receives the first signaling and the second signaling. The TEID is allocated by the UPF entity 143 and is non-repeatable. The SMF entity 141 can apply for a TEID of a certain interface from the UPF entity 143 by calling CreatePDR function. In the existing TEID uniqueness test case, it is necessary to trace traffic between the UPF entity 143 and the SMF entity 141, trigger the maximum number of N4 session establishment requests, capture N4 session establishment responses sent from the UPF entity 143 to the SMF entity 141, and verify that the TEID established for each generated response is unique. However, information transmitted through the N4 interface is not easy to obtain, which makes it difficult to complete the TEID uniqueness test cases for the SMF entity 141 and the UPF entity 143. Therefore, the information security detection method of the present embodiment captures information of N3 interface, which is easier to obtain, so as to reduce the difficulty of executing the TEID uniqueness test cases.

In step S30, when the UE 13 receives the PDU session resource setup request signaling M13 and the PDU session establishment accept signaling M14 through the first interface 15 (e.g., N2 interface) of the base station 12, the PDU session resource setup request signaling M13 and the PDU session establishment accept signaling M14 include the TEID corresponding to the PDU session. Therefore, the TEID value can be recorded while capturing packets through the information security detection device. Next, the UE 13 can send a PDU session resource setup response M15 to the AMF entity 140 through the base station 12 to request allocation of resources for the PDU session. After receiving the response, the AMF entity 140 initiates a session management context update request M16 to the SMF entity 141. After returning a request success message M17, the SMF entity 141 sends a PDCP session modification request M18 to the UPF entity 143, and the UPF entity 143 then updates the TEID corresponding to the PDU session and returns a PDCP session modification response M19 to the SMF entity 141, so as to establish a communication path for the PDU session.

Step S31: configuring the UE to send an Internet control message protocol (ICMP) ping request to the core network through the base station.

In step S31, the UE 13 can transmit an ICMP ping request M20 to the UPF entity 143 of the core network 14 through the base station 12, and the UPF entity 143 then transmits the ICMP ping request M20 to the data network 145 of the core network 14. In response to receiving the ICMP ping request M20, the data network 145 returns an ICMP ping reply M21. When receiving the reply from the data network 145, the UPF entity 143 returns the ICMP ping reply M21 to the UE 13 through the N3 interface of the base station 12.

Step S32: in response to the UE receiving an ICMP ping reply from the core network through an N3 interface of the base station, recording a response quantity of receiving the ICMP ping reply, and configuring the UE to transmit the uplink NAS transport message and the PDU session establishment request to the core network again.

Step S33: in response to the response quantity reaching a predetermined quantity, configuring the information security detection device to determine whether a quantity of the recorded TEID value is the same as the response quantity.

In response to determining that the quantity of the recorded TEID value is the same as the response quantity, the information security detection method proceeds to step S34: configuring the information security detection device to determine whether or not each of the recorded TEID values is unique.

In this way, whether or not the SMF entity and the UPF entity pass the TEID uniqueness test cases can be determined.

In response to determining that the quantity of the TEID values recorded is different from the response quantity in step S32, the information security detection method proceeds to step S35: determining that the SMF entity and the UPF entity fail the TEID uniqueness test cases.

In response to determining that each of the recorded TEID values is unique in step S33, the information security detection method proceeds to step S36: determining that the SMF entity and the UPF entity pass the TEID uniqueness test cases, respectively.

In response to determining that each of the recorded TEID values is not unique in step S33, the information security detection method proceeds to step S35: determining that the SMF entity and the UPF entity fail the TEID uniqueness test cases.

Therefore, in the present embodiment, in addition to obtaining the TEID by capturing and analyzing the packets of the N2 interface, the ICMP ping request M20 is also sent to capture and analyze the packets of the N3 interface, so as to determine the quantity and uniqueness of the obtained TEID values. In this way, the difficulty of obtaining necessary information (e.g., N4 interface) required for information security test cases, and the TEID uniqueness test case for SMF defined in section 4.2.2.1.2 of TS 33.515 and the TEID uniqueness security test case for UPF defined in section 4.2.2.6 of TS 33.513 can be implemented in a simpler manner.

It should be noted that in the above-mentioned embodiments of the present disclosure, all or part of the AMF entity 140, the SMF entity 141, the PCF entity 142, the UPF entity 143, the UDM entity 144 and the data network 145 included in the core network 14 can be implemented through software, hardware, firmware or any combination thereof. When implemented using software, all or part of the embodiments can be implemented in a form of a computer program product. This computer program product includes one or more computer instructions. When the computer program instructions are loaded and executed by the computer, all or part of the processes or functions according to the embodiments of the present disclosure are generated. The computer can be a general-purpose computer, a special-purpose computer, a computer network, or other programmable device. The computer instructions can be stored in or transferred from a computer-readable storage medium to another computer-readable storage medium. For example, computer instructions can be transmitted from one website, computer, server, or data center to another by wired (e.g., coaxial cable, fiber optics, or digital subscriber) or wireless (e.g., infrared, radio, or microwave) means. The computer-readable storage medium can be any available medium that can be accessed by a computer, or can be a data storage device that integrates one or more available medium, such as a server or data center. Available medium can be magnetic medium (e.g., floppy disk, hard disk or tape), optical medium (e.g., DVD), and semiconductor medium (e.g., solid state disk).

### Beneficial Effects of the Embodiments

In conclusion, in the information security detection method and information security detection device provided by the present disclosure, packets of the N2 interface and the N3 interface can be captured and analyzed, while referring to the UP security policy of the UDM entity, so as to reduce the difficulty of obtaining the necessary information required for the information security test cases, and implement certain SMF and UPF security test cases in a simpler way, thereby greatly improving the feasibility of realizing such information security test cases.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An information security detection method, applicable to executing following processes in response to a user equipment (UE), a base station and a core network establishing a connection, comprising:
configuring the UE to transmit an uplink non-access stratum (NAS) transport message and a protocol data unit (PDU) session establishment request to the core network through the base station;
configuring the base station to receive a first signaling and a second signaling from the core network through an N2 interface;
capturing the first signaling by an information security detection device, and determining whether or not the first signaling contains a security indication information element (IE); and
in response to the information security detection device determining that the security indication IE is contained in the first signaling, configuring the information security detection device to determine whether or not the security indication IE is consistent with a user plane (UP) security policy of a unified data management (UDM) entity of the core network, so as to determine whether or not a session management function (SMF) entity of the core network passes a first security test case.

2. The information security detection method according to claim 1, wherein the UE receives the first signaling and the second signaling from an access and mobility function (AMF) entity through the N2 interface of the base station, the first signaling is a PDU session resource setup request signaling, and the second signaling is a PDU session establishment accept signaling.

3. The information security detection method according to claim 2, wherein, in response to the information security detection device determining that the security indication IE is the same as the UP security policy of the UDM entity, the SMF entity is determined to pass the first security test case;
in response to the information security detection device determining that the security indication IE is different from the UP security policy of the UDM entity, the SMF entity is determined to fail the first security test case.

4. The information security detection method according to claim 2, further comprising:
recording a tunnel endpoint identifier (TEID) value by the information security detection device when the base station receives the first signaling and the second signaling;
configuring the UE to send an Internet control message protocol (ICMP) ping request to the core network through the base station;
in response to the UE receiving an ICMP response request from the core network through an N3 interface of the base station, recording a response quantity of receiving the ICMP response request, and configuring the UE to transmit the uplink NAS transport message and the PDU session establishment request to the core network again;
in response to the response quantity reaching a predetermined quantity, configuring the information security detection device to determine whether a quantity of the recorded TEID value is the same as the response quantity;
in response to determining that the quantity of the recorded TEID value is the same as the response quantity, configuring the information security detection device to determine whether or not each of the recorded TEID values is unique, so as to determine whether or not the SMF entity passes a second security test case and a user plane function (UPF) entity passes a third security test case.

5. The information security detection method according to claim 3, wherein, in response to determining that the quantity of the TEID values recorded is different from the response quantity, configuring the information security detection device to determine that the SMF entity fails the second security test case of and the UPF entity fails the third security test case;
in response to determining that each of the recorded TEID values is unique, configuring the information security detection device to determine that the SMF entity passes the second security test case and the UPF entity passes the third security test case;
in response to determining that any one of the recorded TEID values is not unique, configuring the information security detection device to determine that the SMF entity fails the second security test case and the UPF entity fails the third security test case.

6. The information security detection method according to claim 3, further comprising: configuring the base station to disable an encryption mechanism of the N2 interface and the N3 interface, or configuring the information security detection device to establish a connection with a security gateway of the core network before the UE sends the uplink NAS transport message and the PDU session establishment request to the core network.

7. The information security detection method according to claim 2, wherein, in response to determining that the security indication IE is not contained in the first signaling, configuring the information security detection device to further determine whether a first parameter and a second parameter of the UP security policy of the UDM entity comply with a predetermined configuration, so as to determine whether or not the SMF entity passes the first security test case.

8. The information security detection method according to claim 2, wherein the UE transmits the uplink NAS transport message and the PDU session establishment request to the AMF entity of the core network through the base station, the AMF entity transmits a PDU session establishment message to the SMF entity, the SMF entity communicates with a policy control function (PCF) entity of the core network, and transmits a packet data convergence protocol (PDCP) session establishment request to the UPF entity.

9. The information security detection method according to claim 8, wherein, in response to receiving a PDCP session establishment response from the UPF entity, the SMF entity obtains the UP security policy from the UDM entity.

10. The information security detection method according to claim 4, wherein the UE transmits the ICMP ping request to the UPF entity of the core network through the base station, the UPF entity transmits the ICMP ping request to a data network (DN) of the core network, and transmits the ICMP response request to the UE in response to receiving a response from the DN.

11. An information security detection device, comprising:
a memory storing a plurality of instructions; and
a processing circuit electrically connected to the memory, wherein the processing circuit is configured to read the instructions and execute following processes:
communicatively establishing a connection through a user equipment (UE), a base station and a core network;
configuring the UE to transmit an uplink non-access stratum (NAS) transport message and a protocol data unit (PDU) session establishment request to the core network through the base station;
configuring the UE to receive a first signaling and a second signaling from the core network through an N2 interface of the base station;
capturing the first signaling and checking whether or not the first signaling contains a security indication information element (IE); and
in response to determining that the security indication IE is contained in the first signaling, determining whether or not the security indication IE is consistent with a user plane (UP) security policy of a unified data management (UDM) entity of the core network, so as to determine whether or not a session management function (SMF) entity of the core network passes a first security test case.

12. The information security detection device according to claim 11, wherein the UE receives the first signaling and the second signaling from an access and mobility function (AMF) entity through the N2 interface of the base station, the first signaling is a PDU session resource setup request signaling, and the second signaling is a PDU session establishment accept signaling.

13. The information security detection device according to claim 12, wherein, in response to determining that the security indication IE is the same as the UP security policy of the UDM entity, the processing circuit is configured to determine that the SMF entity passes the first security test case;
in response to determining that the security indication IE is different from the UP security policy of the UDM entity, the processing circuit is configured to determine that the SMF entity fails the first security test case.

14. The information security detection device according to claim 12, wherein the processing circuit is further configured to read the instructions and execute following processes:
recording a tunnel end identifier (TEID) value in response to the UE receiving the first signaling and the second signaling;
configuring the UE to send an Internet control message protocol (ICMP) ping request to the core network through the base station;
in response to the UE receiving an ICMP ping reply from the core network through an N3 interface of the base station, recording a response quantity of receiving the ICMP ping reply, and configuring the UE to transmit the uplink NAS transport message and the PDU session establishment request to the core network again;
in response to the response quantity reaching a predetermined quantity, determining whether a quantity of the recorded TEID value is the same as the response quantity; and
in response to determining that the quantity of the recorded TEID value is the same as the response quantity, determining whether or not each of the recorded TEID values is unique, so as to determine whether or not the SMF entity passes a second security test case of and a user plane function (UPF) entity passes a third security test case.

15. The information security detection device according to claim 13, wherein, in response to determining that the quantity of the TEID values recorded is different from the response quantity, the processing circuit is configured to determine that the SMF entity fails the second security test case of and the UPF entity fails the third security test case;
in response to determining that each of the recorded TEID values is unique, the processing circuit is configured to determine that the SMF entity passes the second security test case and the UPF entity passes the third security test case; and
in response to determining that any one of the recorded TEID values is not unique, the processing circuit is configured to determine that the SMF entity fails the second security test case and the UPF entity fails the third security test case.

16. The information security detection device according to claim 13, wherein the processing circuit is further configured to read the instructions and execute following processes:
before the UE sends the uplink NAS transport message and the PDU session establishment request to the core network, configuring the base station to disable an encryption mechanism of the N2 interface and the N3 interface, or establishing a connection with a security gateway of the core network.

17. The information security detection device according to claim 12, wherein the processing circuit is further configured to read the instructions and execute following processes:
in response to determining that the security indication IE is not contained in the first signaling, further determining whether a first parameter and a second parameter of the UP security policy of the UDM entity comply with a predetermined configuration, so as to determine whether the SMF entity passes the first security test case.

18. The information security detection device according to claim 12, wherein the UE transmits the uplink NAS transport message and the PDU session establishment request to the AMF entity of the core network through the base station, the AMF entity transmits a PDU session establishment message to the SMF entity, the SMF entity communicates with a policy control function (PCF) entity of the core network, and transmits a packet data convergence protocol (PDCP) session establishment request to the UPF entity.

19. The information security detection device according to claim 18, wherein, in response to receiving a PDCP session establishment response from the UPF entity, the SMF entity obtains the UP security policy from the UDM entity.

20. The information security detection device according to claim 14, wherein the UE transmits the ICMP ping request to the UPF entity of the core network through the base station, the UPF entity transmits the ICMP ping request to a data network (DN) of the core network, and transmits the ICMP ping reply to the UE in response to receiving a reply from the DN.
